(19) United States
(12) Patent Application Publication
(10) Pub. No.: US 2004/0131052 A1
(43) Pub. Date: Jul. 8, 2004

(54) Method and system for a dynamically assigned broadband network

(76) Inventors: Stephen A. Smith, Van Alstyne, TX (US); Thyagaraj Devasigamani, Allen, TX (US); Huong C. Ho, Plano, TX (US); David Q. Bui, Plano, TX (US); Richard Hofstra, Plano, TX (US)

Correspondence Address: Michael G. Cameron, Jackson Walker LLP., Suite 600, 2435 North Central Expressway, Richardson, TX, 75080, US

(21) Appl. No.: 10/682,294

(22) Filed: Oct. 9, 2003

Related U.S. Application Data
(60) Provisional application No. 60/417,546, filed on Oct. 10, 2002.

(51) Int. Cl. H04L 12/66

(52) U.S. Cl. 370/352

(57) ABSTRACT

The present invention comprises a method and system for allowing end users to dynamically setup broadband networks on demand. It utilizes a regular phone call to determine the end points of the broadband call and it may use portions of, or the complete path of, the DS0 path through the network to setup the broadband network. Three embodiments of the present invention are described, one that associates a phone with a broadband line and essentially mimics the narrowband call with the broadband call, a second that allows for an intermediary call center to determine the end points of the broadband call based on the calling number and a secondary call to the destination number and a third that allows for new pieces of equipment at the customer premise and in the network to establish the broadband call by allowing direct communications between the CPE equipment and the SS7 network.

### CROSS REFERENCE TO RELATED APPLICATION

This application is related to U.S. provisional patent application No. 60/417,546, filed Oct. 10, 2002, entitled “METHOD AND SYSTEM FOR SS7 TRIGGERED BROADBAND COMMUNICATIONS”, the entire contents of which are incorporated herein by this reference. The Applicants hereby claim the benefits of this earlier pending provisional application under 35 U.S.C. Section 119(e).

### TECHNICAL FIELD OF THE INVENTION

The present invention relates to the dynamic management of broadband circuits such as T1s, DS3s and OC3s using non-broadband guide wires. A number of different methods can be utilized for determining the path and the end termination points of the broadband call.

### BACKGROUND OF THE INVENTION

In U.S. Pat. No. 6,452,924 to Golden, et al. (“Golden”), a method of connecting computer (e.g., internet protocol or “IP”) networks together over multiple increments of broadband circuits, such as T1s, is described. In contrast to Golden, the present invention application is not limited to a specific type of data, such as IP. The present invention is protocol agnostic since the terminating pieces of CPE equipment set the protocol for the connection. Advantageously, the present invention can be triggered from the SS7 network by placing a phone call to CPE equipment that sets the terminal points and suggests the path, and then triggers the broadband network to set up the broadband call. Disadvantageously, Golden is limiting in that it is based on assigning IP connections to the T1s as a subnet. The present invention is adapted to provide the same connectivity from a computer to computer perspective, but can also provide connectivity for many other applications as well, such as switch-PBX, premise alarm-monitoring station, and similar connections.

### BRIEF SUMMARY OF THE INVENTION

The present invention relates to the dynamic management of broadband circuits such as T1s, DS3s and OC3s. The present invention can utilize many different methods for determining the path and the end termination points of the broadband call.

A first embodiment of the present invention, as further described herein, is to associate a POTS line/DS0 or telephone line with a broadband line. The broadband line can be configured to mimic the end points and the path of the DS0 call. A second embodiment of the present invention, also as described herein, utilizes a call center to act as an intermediary for placing the broadband call. In the second embodiment, a POTS line is used to trigger the event. A third embodiment of the present invention, also as described herein, identifies an active network interface device that communicates with the PSTN to direct the broadband call. The foregoing methods comprise only three embodiments, of a number of embodiments, that can dynamically allocating broadband bandwidth within the transport network to setup broadband pipes “on demand.”

### DESCRIPTION OF THE DRAWINGS

FIG. 1 illustrates a means of connectivity between two branches of a company;

FIG. 2 is a block diagram of a high level network, showing the interconnections between the network elements, the EMS′, the end offices, the branch offices, the special NMS, and the SS7 network;

FIG. 3 illustrates a call center implementation of the present invention for setting up the dynamic broadband network;

FIG. 4 illustrates a means of setting up the dynamic broadband network with a Q.931 link from the SS7 network to the subscriber's premise;

FIG. 5 illustrates a call center implementation of the present invention used in conjunction with the SS7 network;

FIG. 6 illustrates a high level network and the interconnections with the SS7 network including the SSPs, STPs, SCPs, and their relation to the SNMS; and

FIG. 7 illustrates the HLSNMS and its relation to the SNMS network.

### DETAILED DESCRIPTION OF THE PRESENT INVENTION

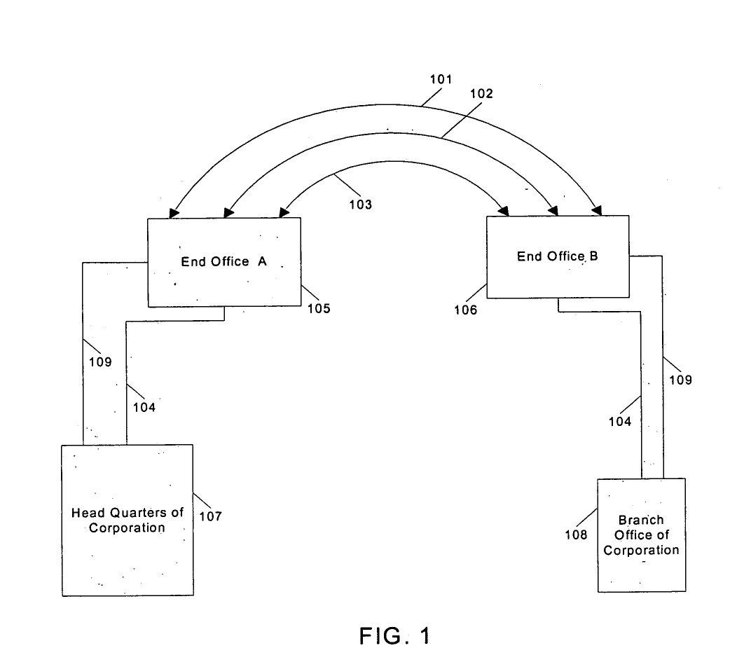

FIG. 1 illustrates a means of connectivity between two branches of a company. Referring to FIG. 1, a video conference bridge of 3 Mb/s symmetrical bandwidth is setup between a main headquarters office 107 and a branch office of a corporation 108. The connectivity from the businesses to the local end central offices are two HDSL channels 104, that are always synchronized. There is a pool of resources 101, 102, 103 from which the connections will be made. In this example, two of the resources are required 101, 102 between the two end offices 105, 106, however, the resources for the connection are not established until the broadband call is initiated.

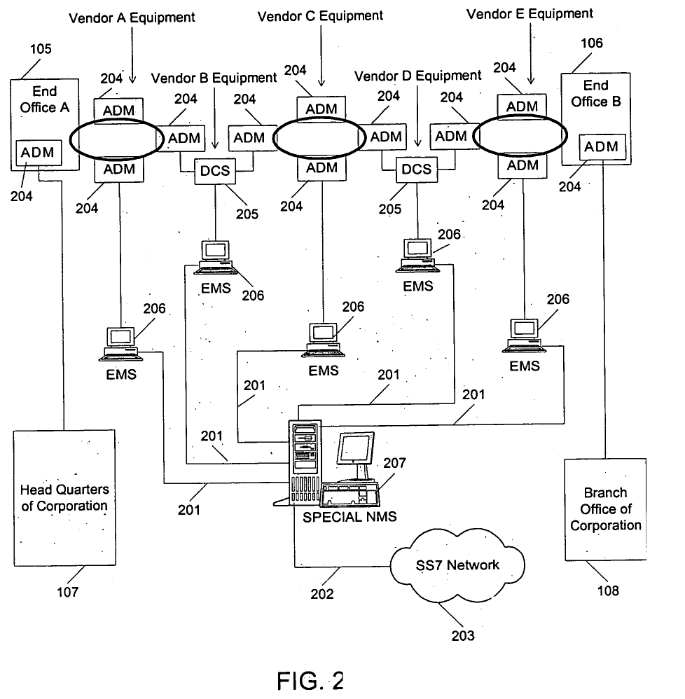

FIG. 2 is a block diagram of the first embodiment of the present invention, comprising a high level network, showing the interconnections between the network elements, the EMS′, the end offices, the branch offices, the SNMS, and the SS7 network. Referring to FIG. 2, there is an association made at the SS7 level between the POTS line 109 and the broadband line(s) 104 at the originating party's location. There is an independent association between the POTS line 109 and the broadband line(s) 164 at the destination location from the end office 105. When the main headquarters office 107, the originating party, wants to setup a videoconference with the branch office 108, the destination party, it first establishes a voice call to the destination party, which the SS7 network processes. The PSTN network, via the SS7 network establishes the DS0 call and then queries the destination party to determine if it is equipped, e.g., it has subscribed to the service, to setup the broadband conference call. If not, then only the DS0 call will be established. If the destination party can support a broadband call, then the broadband call is initiated as follows:

1. As part of a database for customers, a set of DS1s/VT1.5, 101, 102 (granular units or bearer channel) will be allocated for the broadband call. As seen in FIG. 2, once the number of DS1s/VT1.5 (granular units) is determined, then SNMS 207 is queried for resources along the broadband path. The broadband path can traverse any network element 204, 205 that can be remotely provisioned and can support a DS1 or VT1.5 granular unit provisioning. Higher granular units, such as STS1 units can also be provisioned if needed. The present invention can utilize existing network elements that have spare capacity or it can consist of a totally separate overlay network. The broadband path can also cross LATA and carrier boundaries by passing through gateway network elements.

2. The special network manager 207, with the help of the SS7 203 information as the guide-wire, determines the best path for the broadband call. If a complete path can not be setup to the capacity that was initially requested, it can setup the broadband call to the highest level of granular units' possible.

3. After the special network manager 207 has determined the best path for the broadband call and reserved the resources necessary to implement it, it will issue a series of provisioning commands to all of the targeted network elements 204, 205, to provision the broadband channels. The special network manager will track the resources that are being used to ensure that it doesn't deplete all of the granular unit resources and so that additional calls will not use the same resources.

4. Supervision tones or messages of the broadband call will be passed to the user over the DS0 call via the SS7 network 203 and local switch so that the user can determine the status of the broadband call and can terminate or make further changes to the broadband call, as needed.

SNMS 207 operates between the SS7 network 203 and the EMS systems 206 of the individual network elements 204, 205. The SNMS 207 communicates with the EMS network 206 over a standard CORBA interface 204, 205 if the vendor equipment supports it. If the equipment does not support CORBA, then SNMS 207 communicates with the equipment over TL1 or SNMP. The SNMS communicates to the SS7 network.

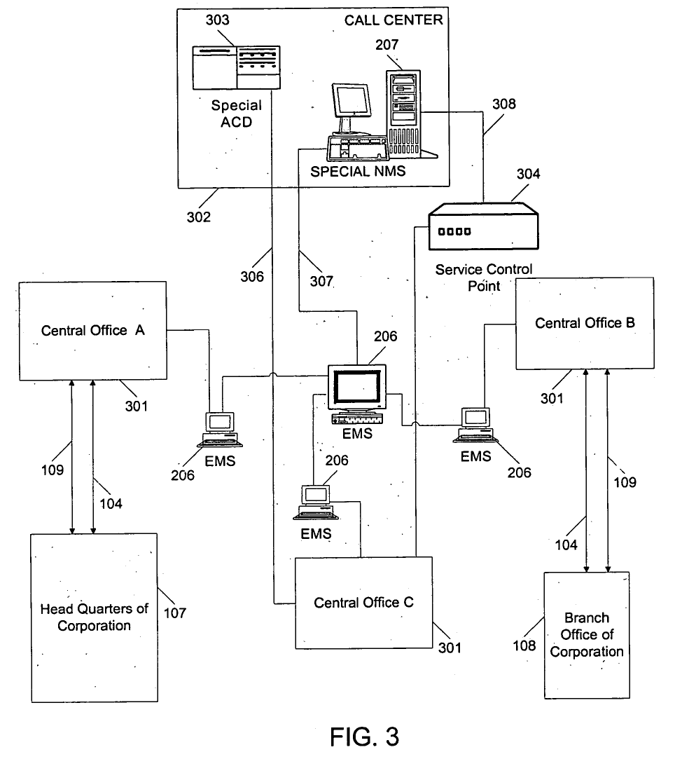

The second embodiment of the present invention is seen in FIG. 3. In FIG. 3, the broadband network is dynamically set up by utilizing a special call center 302 with the following steps:

1. A user 109 wishing to place a broadband call, dials a toll free or a local number to a call center 302.

2. The call center 302 terminates the call with the special automated call distributor (“SACD”) 303, and retrieves the caller's phone number and service agreement either by accessing the SCP database 304 or by retrieving the caller ID information and querying its internal database.

3. The SACD 303 requests the destination phone number, which the subscriber then provides via DTMF tones.

4. Upon receiving the digits, the call center 302 determines the destination number's 109 service agreement and if it is capable of receiving a broadband call by querying an internal database.

5. The caller then receives tones or voice messages over the phone from the SACD 303 to inform him/her of the broadband call's progress in setting up the broadband link.

6. Upon the broadband call's setup completion, the caller is notified that the broadband call is established. The caller can choose to hang up the phone to the call center, or continue to listen for additional supervision messages.

7. Upon the end of the broadband call, if the originator chose to continue the DS0 call, then additional DTMF digits will terminate the call. Otherwise, a call must be placed either by the calling party 109 or called party 109 to tear down the connection. If neither party tears down the service, the call may be automatically terminated after a programmable amount of time.

8. Billing will take place for the duration of the broadband call after it is established.

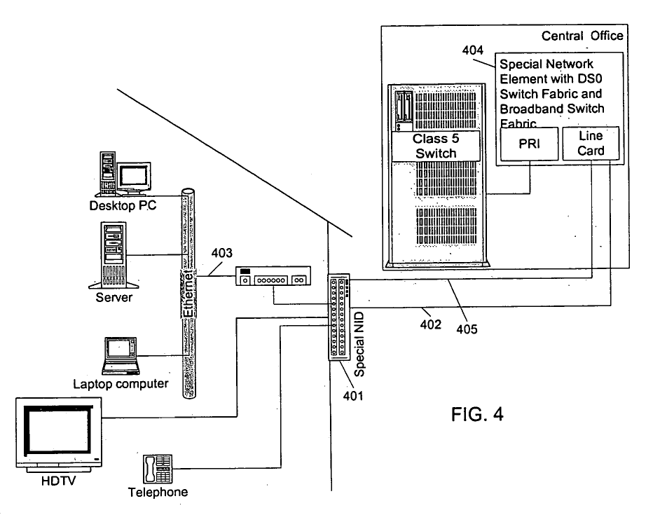

The third embodiment of the present invention is seen in FIG. 4. In FIG. 4, a special network interface device (“SNID”) 401 must reside on the customer premise that will be the interface between the end user and the PSTN network, via a special piece of network equipment (“SNE”) 404. SNID 401 has a physical Ti or HDSL line 405 with an Q.931 interface 402 or an equivalent communication link back to the SS7/SCP 304 network for communicating the subscriber's network requests. The SS7 304 network communicates with the SNID 401 over the Q.931 402 interface and the SNID 401 translates these messages into audible tones, audible messages, or screen messages to the subscriber 404. The SNE 404 will interface to the Class 5 switch, via a standard interface such as PRI to process DS0's and the Q.931 channel. The SNE 404 has the capability to connect a subscriber broadband link to a network broadband link, upon command from an EMS or SNMS. The SNE 404 may have the capability to oversubscribe the network resources such that it can serve many more subscribers than are available as network resources. Thus, the SNE 404 effectively becomes a distributed broadband switching network element, and can be used as a building block for establishing an entire broadband network, based upon its Q.931 interface (or equivalent) and it's oversubscribed switching fabric. The following steps describe the broadband call setup:

1. When the user wants to place a broadband call, he/she will signal to the SNID 401 via a device such as a remote control, phone, or computer command which will send a message to the network via the Q.931 402 interface, entering which user device 403 the channel is to be connected to and the destination phone number.

2. The network will issue supervision messages to the user informing him/her of the status of the broadband call setup. The supervision messages can be Q.931 402 codes to the SNID 401, which will then interpret the codes and send the corresponding user message depending on the device that is being used to activate the broadband call.

3. Upon completion of the broadband call setup, the network will inform the user and start the billing process. The call can be timed so that if the user does not terminate the call in a reasonable time period, the call and the billing will be automatically terminated.

4. Upon completion of the call, either party can terminate the call by sending additional messages to the network via the SNID 401 over the Q.931 402 message.

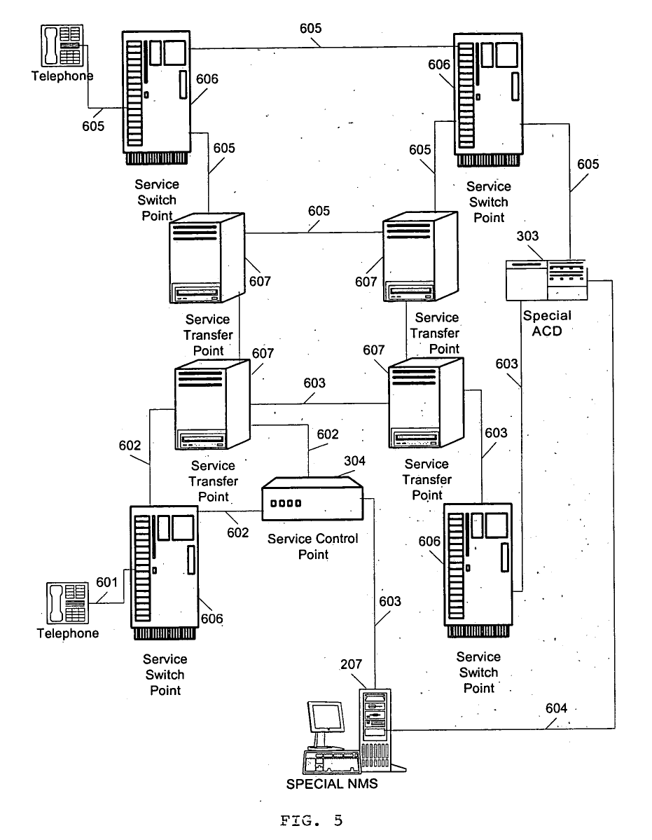

Now, examining the three embodiments of the present invention in more detail, reference is made to FIG. 5. FIG. 5 illustrates the POTS Line/Broadband Line Association of the first embodiment of the present invention. Referring to FIG. 5, the narrowband call setup and supervision consists of four distinct components:

1. Service Switch Point (“SSP”) 606: telephone switch interconnected by SS7 links 602 and physical links 605. The SSPs 606 perform call processing on calls that originate, tandem or terminate at that node. A local SSP in the PSTN can be central office or end office (“EO”).

2. Service Transfer Point (“STP”) 607: A switch that relays SS7 messages between network switches and databases. Based on the address fields of the SS7 messages, the STPs 607 route the messages to the correct outgoing signaling links.

3. SCP 304— Contains databases for providing enhanced services. An SCP 304 accepts queries and returns the requested information.

4. SNMS 207— A Special NMS operates between the SS7 and the broadband network. Based on the information provided by the SCP 304, the SNMS 207 determines the best path for the broadband call. The SNMS 207 uses the TCAP protocol to interface with the SCP 304 in the SS7 network and uses CORBA protocol 207 to interface with the Transport Equipments' (Broadband) EMS 206. It also supports TL1 and SNMP protocol if the equipment does not support CORBA.

The POTS Line/Broadband Line association involves two types of interconnections between the PSTN and the Broadband Network. The signaling interface and the broadband interface. The signaling interface involves access links from SNMS 207 to the PSTN SCP 304 and SSP 606. The broadband interface, with the help of the SS7 information as the guidewire, will determine the best path for the broadband call using granular units 107 or broadband bearer channel. The following steps for call association are described as followed:

1. The originating user 109 dials the phone number to the destination phone number 109 of the user where the broadband call is to take place. The originating user may also dial an 800 toll free number if accessing a service number such as a video server.

2. The SSP 606 originates the SS7 messages after it determines which interoffice trunk will be used to connect a call. In the case of an 800 number, the SSP 606 can not determine how to route the call based on the digits dialed. The 800 number must be converted to a routing number before the switch can determine which trunks to use. The SSP 606 originates a TCAP query to a 800 database located in SCP 304. If the SSP knows the address of the SCP 304, it can send the TCAP signal directly to the SCP 304. Normally, the SSP 606 does not have to know the address of the SCP 304. The message originated must only provide the digits dialed. The STP 607, which is responsible for routing SS7 messages through the network, uses this information to determine which database the query should be sent. The global title translation (“GTT”) in the STP is a facility to determine where a query should be routed. The STP also looks at the signaling connection control part (“SCCP”) to determine what digits were dialed, which is part of the called party address, and makes its routing decision based on these global title digits. The TCAP INVOKE operation is used in this case to invoke an operation on the SCP 304. The SCP 304 sends RETURN RESULT operation to return results back to the STP.

3. The SCP 304 recognizes the called number or the 800 number has a broadband association property, it generates a TCAP INVOKE message to the SNMS 207 in order to verify the POTS Line/Broadband Line Association. If the SNMS 207 verifies that it is equipped (has subscribed to the service) to setup the broadband call, the SNMS 207 sends an acknowledge RETURN RESULT back to the SCP 304. If not, then only the DS0 call will be established.

4. Upon receiving routing information from the SCP 304, the SNMS 207 performs the call validation and broadband call setup. The following operations will be performed in the SNMS 207:

The SNMS 207 performs the call validation. If it's valid information, the SNMS 207 will verify the broadband association. If the SNMS 207 can not validate the user information, a rejection message will be sent to the SCP 304 to inform the user.

If the SNMS 207 can not perform the broadband call setup, the SNMS 207 instructs the SCP 304 to start the call tear down process.

Once the SNMS 207 determines the broadband association, the SNMS 207 uses the TCAP protocol to interface with the SCP 304 in the SS7 network and uses the CORBA protocol 207 to interface with the Transport Equipments' (Broadband) EMS 206. It also support TL1 and SNMP protocol if the equipment does not support CORBA 207. If the SNMS 207 can not perform the broadband setup to the destination number, the SNMS 207 will inform the SCP 304 and start the call tear down process

5. At this point the DS0 call is established and the SNMS 207 is sending provisioning information to the traversed network elements in the broadband route. If the DS0 call does not complete due to the called party being busy or all trunks being busy, the broadband call will be aborted.

6. Once the broadband call is established, it will remain up while the DS0 call is established. Upon either party 109 of the DS0 call hangs up, the broadband call will be terminated, by the SSP notifying the SCP 304, which will then notify the SNMS 207. The broadband trunks that are terminated with the call will then be placed back into the resource pool for use by other subscribers.

As seen in FIG. 5, the second embodiment of the present invention, the call center approach consists of two portions, narrowband and broadband. The narrowband call setup and supervision consists of five distinct components, four of which are identical to the first embodiment, the POTS Line/Broadband Line Association embodiment. The additional component of the second embodiment is:

SACD 303— A Special Automatic Call Distributer (“SACD”) 303 that provides various supervision tones and automated messages to obtain information from the user.

The call center supervision embodiment of the present invention involves the two types of interconnections between the PSTN and the Broadband Special network—the signaling interface and the trunk interface. The signaling interface involves access links from the SACD 303 and SNMS 207 to the PSTN SCP 304 and SSP. The trunk interface represents a physical SS7-supported trunk connection 302 (for voice/data transmission) between the SACD 303 and a PSTN tandem switch or PSTN end-office switch. The following steps for call supervision are described as followed:

1. The user 109 dials up a 800 number or a local number to the end-office telephone switch 302.

2. The SSP originates the SS7 messages after it determines which interoffice trunk will be used to connect a call. In the case of an 800 number, the SSP can not determine how to route the call based on the digits dialed. The 800 number must be converted to a routing number before the switch knows which trunks to use. The SSP originates a TCAP query to a 800 datatase located in SCP 304. If the SSP knows the address of the SCP 304, it can send the TCAP signal directly to the SCP 304. Normally, the SSP does not have to know the address of the SCP 304. The message originated must only provide the digits dialed. The STP, which is responsible for routing SS7 messages through the network, can use this information to determine which database the query should be sent to. The Global Title Translation (GTT) in the STP is a facility to determine where a query should be routed. The STP also looks at the Signaling Connection Control Part (SCCP) to determine what digits were dialed (which is part of the called party address) and makes its routing decision based on these global title digits. The TCAP INVOKE operation is used in this case to invoke an operation on the SCP 304. The SCP 304 sends RETURN RESULT operation to return results back to the STP.

3. The SCP 304 recognizes the 800 number is for call center supervision, it generates a TCAP INVOKE message to SNMS 207 in order to update the SNMS 207 database (called id, end office id). The SNMS 207 sends an acknowledge RETURN RESULT back to the SCP 304.

4. Upon receiving the routing information from the SCP 304, the SSP will issue the ISUP Initial Address Message (IAM) to the SACD 303 to initiate signaling trunk setup. The LAM progresses switch to switch via the STPs to the SACD 303. The SSP marks the circuit busy and the information is carried by the IAM. When the IAM arrives to the SACD 303, the SACD 303 will take over the call. The SACD 303 performs the following functions:

a. If the DS0 circuit is idle, the ISUP Address Complete Message (“ACM”) is sent from the SACD 303 back to originated SSP. The message indicates that the routing information required to complete the call has been received by the SACD 303.

b. When the SACD 303 answers the call the ISUP Answer Message (“ANM”) is sent from the SACD 303 to the SSP to indicate that the call has been answered.

c. At this moment the DS0 call is establish through the trunk path. The SACD 303 will request more information from user 109 (i.e. account number and destination number) by issueing a series of interactive voice commands.

d. If the DS0 circuit is busy, the ISUP Release Message (REL) is sent from SACD 303 back to the SSP with a cause indicating the busy line situation. The specified trunk is released, but the trunk is not set to idle until a Release Complete Message (RLC) message is received.

5. The SACD 303 sends the user information (i.e. called number, calling number, network id/called point code) to the SNMS 207 for validation as part of the broadband call setup. The following operations will be performed between SNMS 207 and SACD 303:

a. The SNMS 207 reports to the SACD 303 about the user information validation. If it's a valid information, the SACD 303 will start the DS0 call setup between the SACD 303 and the destination number.

b. If the SNMS 207 can not validate the user information, a rejection message will be sent to the SACD 303 to inform the user. The SACD 303 starts the call tear down process by issuing the Release Message (“REL”).

c. If the SNMS (“207”) can not perform the broadband call setup. The SNMS 207 instructs the SACD 303 to start the call tear down process d. If the SACD 303 can not perform the narrow band setup to the destination number. The SACD 303 will inform the SNMS 207 and start the call tear down process

6. The SACD 303 starts dialing the destination number based on the user information from Step 4, the narrowband call setup to the destination number 109 will begin. This ISUP call setup performs the same operations as Step 4, this time the SACD 303 is the call originator. Once the voice circuit is connected, the SACD 303 informs the calling user about the status of the broadband call. If the calling user accepts the broadband call, the SACD 303 will inform the SNMS 207 to complete the broadband call. The billing is started from this point. The SACD 303 may instruct the calling user to hang up the phone. The trunk between calling user 109 and called user will be released 109.

7. In order to tear down the broadband call either the called user 109 or calling user 109 makes another 800 number to inform the SACD 303 of the broadband call termination. If the DS0 call has been up for the duration of the broadband call, either party can sent DTMF digits to the SACD 303 to tear down the call. The SACD 303 instructs the SNMS 207 to tear down the broadband connection and stop the billing. If neither party 109 makes the tear-down call, the call may be automatically be terminated after a pre-determined amount of time, so as not to permanently tie up the Broadband equipment 204, 205.

The third embodiment of the present invention is the SNID approach. As seen in FIG. 4, this implementation of this embodiment requires additional equipment at the subscriber's premise such as the SNID 401. This embodiment advantageously provides the capability of eliminating the call center SACD 303 and for providing additional broadband capabilities.

The call setup of this approach is the same as the call supervision embodiment of the present invention, except it has a Q.931 (or an equivalent/similar) 402 interface to the SS7/SCP 304 network for sending user information directly to the SS7 network. The SNID 401 requests broadband access by issuing Q.931 setup messages to the SS7/SCP network 304. Once the SS7/SCP 304 network receives the request from the SNID 401, the SS7/SCP 304 network performs all the steps as the call supervision embodiment. The out-of-band SS7 common channel signaling is used to setup the narrowband (voice) call. This call is set up as a guide wire to establish the broadband path between the originating and terminating subscriber's broadband termination points. The SNE 404 will interface to the Class 5 switch, via a standard interface such as PRI to process DS0's and the Q.931 channel. The SNE 404 will also have the capability to connect a subscriber broadband link to a network broadband link, upon commands from an EMS or SNMS 207. The SNE 404 may have the capability to oversubscribe the network resources such that it can serve many more subscribers than are available as network resources. Thus the SNE 404 effectively becomes a distributed broadband switching network element, and can be used as a building block for establishing an entire broadband network, based upon its Q.931 interface (or equivalent) and the oversubscribed switching fabric. The special broadband network is organized as domains. The special broadband network domain scopes to the Local Exchange Carrier (“LEC”) LATA (local access transport area as defined in SR-TSV-002275) and the Inter-Exchange Carrier (IXC) network. As used herein, the broadband network within each LEC LATA is referred to as “domain” and the broadband path within this domain as “Intra-domain connection”. The broadband network within each IXC network is referred to as “Inter-carrier domain” and the broadband path within this domain as “Inter-carrier domain connection”. The broadband connection between two LEC LATA is referred to as “Inter-domain connection”.

For Inter-domain broadband services, the broadband path may transcend multiple domains including Inter-carrier domains to provide end-to-end broadband connections. Inter-domain connections are established by setting up the broadband path within a domain and then connecting the out-going broadband termination point to the IXC gateway or adjacent LEC gateway. The broadband gateway is analogous to the point of presence (“POP”) in the narrow-band network configuration. It is designated by the IXC for the connection of its broadband facilities to the broadband facilities of a LEC: Typically, a broadband gateway will be collocated within the domain that the IXC serves. An IXC may have more than one POP (and gateway) within a domain. IXC designates at each broadband gateway a physical broadband-termination point (“BBTP”). The BBTP provides a clear demarcation between: the domain's access point and the IXC's inter-domain access point. This information is further used for billing and accounting purposes.

A particular configuration of the special broadband network is defined as a network configuration. A network configuration spans over multiple LEC and IXC domains. A network configuration must be able to make a broadband connection between any two broadband termination-points. A number of different network configurations are possible depending on the LEC and the IXC broadband network configurations.

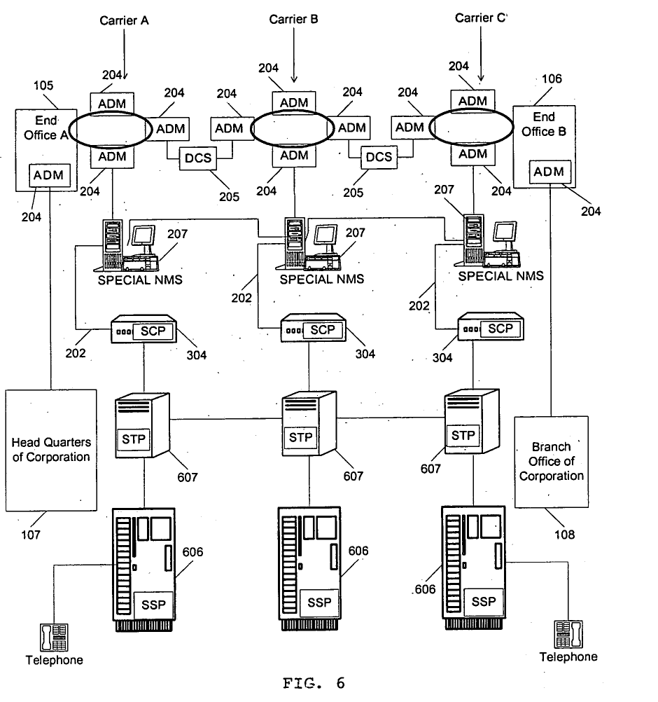

Referring to FIG. 6, a LEC or IXC broadband network is defined as a special domain and is managed by the Special NMS (“SNMS”) 207. Typically each SNMS 207 domain will include thousands of broadband access and transport nodes 204, 205 comprising of DCS, ADMs, OADMs, DWDMs, Optical switches, and other transport equipment capable of being remotely provisioned.

During the broadband connection setup, each SNMS 207 needs to identify the termination points within it domain. The termination points may be the originating or terminating subscriber's broadband termination points at the DCS or the gateway termination points to the IXC and adjacent domains (same or different LEC). To establish the broadband connection the special system stores and accesses network configuration information in the Service Control Point (“SCP”) 304 and the SNMS 207 databases. The network configuration information comprises of the domain's broadband network composition and the broadband subscriber's data.

Each SNMS 207 stores data pertaining to its domain that is required to establish the broadband connection within its domain. As seen in Table 1, this data includes but is not limited to:

1. Complete topology of the broadband network within its domain comprising of broadband access and transport network elements (nodes).

2. List of broadband subscribers and their broadband termination points including End-System ID and subscriber broadband access termination points.

3. Resources available at each of the broadband nodes. The SNMS 207 periodically communicates with the network elements and updates the resource availability.

4. Routing table that is built based on the available resources.

TABLE 1
Broadband Domain Configuration Data

| NETWORK | STORAGE | |
|---|---|---|
| DOMAIN DATA | LOCATION | COMMENTS |
| SNMS ID | SNMS, SCP | IP Address, Port No. |
| NODE ID | SNMS | TID, IP Address |
| SNMS Adjacency Table | SNMS | List of Adjacent domains and |
| | | the IP Address to the |
| | | corresponding SNMS |
| BB Gateway | SNMS | List of GW termination points |
| Adjacency Table | | to Adjacent domains. Node |
| | | and Port ID |
| IC Gateway Table | SNMS | List of GW termination points |
| | | to IC domains. Node and Port |
| | | ID |
| Network Composition | SNMS | List of active nodes and the |
| Table | | network topology. |

The subscriber user data is stored in the SCP 304 and the SNMS 207. The subscriber user information may be stored, as class feature data just like it is currently stored in the SCP 304. This information is made available from anywhere in the PSTN network by the SS7 network. The mapping of the SNMS 207 address to the subscriber ID is required for the broadband path setup in the special system.

TABLE 2
Subscriber User Data

| | STORAGE | |
|---|---|---|
| SUBSCRIBER DATA | LOCATION | COMMENTS |
| Subscriber ID | SNMS, SCP | |
| End Station ID | SNMS, SCP | |
| Broadband Termination Point | SNMS | Subscriber's BB |
| | | Termination point: |
| | | Terminating Equipment |
| | | and Port ID |
| SNMS ID | SCP | Mapping of subscribers |
| | | SNMS, IP Address and |
| | | Port No. |
| Bandwidth subscription | SNMS | VTs, T1-Bonding, |
| | | HDSL, DS3/STS |
| | | bandwidth subscription |
| Pre-Configured Destination | SNMS, SCP | ISP, SAN, ASP, |
| Type | | Home/Remote Office |
| Subscription Plan Type | SNMS, SCP | Access code required, |
| | | Pre-authorized (pre-paid), |
| | | Pre-defined Originating TP, |
| | | Pre-defined Destination TP |
| Default IXC | SNMS, SCP | Subscribers Inter- |
| | | Exchange Carrier ID |
| Called Party Address | SNMS, SCP | |
| Calling Party Address | SNMS, SCP | |
| Origination Point Code | SNMS, SCP | |
| Destination Point Code | SNMS, SCP | |
| Subsystem Number | SNMS, SCP | |

The SNMS 207 has control of each domain. The broadband nodes 204, 205 and the associated EMS/NMS 206 make up the domain configuration. The domain configuration and the local topology information is part of the SNMS 207 database. The SNMS 207 manages all of the allocated broadband resources of these network elements. The SNMS 207 communicates with the network elements via the EMS/NMS 206 or directly depending on the service provider's management system architecture.

The call setup message is used to exchange broadband call setup information between SNMS 207. The SNMS 207 of the domain in which the call originates constructs the initial call setup message. The call setup message contains the information set forth in Table 3:

TABLE 3
Initial Call Setup message:
Calling Subscriber ID
Called subscriber ID
SNMS address of the Calling Subscribers domain
SNMS address of the Called Subscribers domain
Subscriber's user data.

TABLE 4
Intermediate Call Setup message:
Calling Subscriber ID
Called subscriber ID
SNMS address of the Calling Subscribers domain
SNMS address of the Called Subscribers domain
Subscriber's user data.
SNMS address of the Intermediate domain
Intermediate domain Gateway Port ID

As seen in Table 4, the intermediate call setup message is created by the SNMS 207 in the intermediate domains by adding the address of its SNMS 207 and the gateway port to which it terminates the broadband path within its domain.

For an Intra-domain call, if the SNMS 207 address of the calling subscriber's domain and the called subscriber's domain in the call setup message is the same as the local SNMS 207, then the call is identified as an Intra-domain call.

For an Inter-domain call, if the SNMS 207 address of the calling subscriber's domain and the called subscriber's domain in the call setup message is not the same as the local SNMS 207, then the call is identified as an inter-domain call.

For originating domain calls, if the SNMS 207 address of the calling subscriber's domain is the same as the local SNMS 207 and the called subscriber's domain is not the same as the local SNMS 207, then the call is identified as an originating domain call.

For terminating domain calls, if the SNMS 207 address of the called subscriber's domain is the same as the local SNMS 207 and the calling subscriber's domain is not the same as the local SNMS 207, then the call is identified as a terminating domain call.

It is the responsibility of each SNMS 207 to establish the broadband path within its domain. The broadband connection may originate and terminate within the same domain or span over multiple SNMS 207 domains. If the broadband connection spans beyond an SNMS 207 domain, the SNMS 207 will reserve the bandwidth for the path within its domain and send a connection request to the SNMS 207 in the adjacent domain.

The different call scenarios can be broadly classified as Intra-domain Calls, Inter-domain Calls (same or different LECs), and Inter-domain Inter-Exchange Carrier Calls. In the peer-to-peer mode, the SNMSs 207 communicate with each other directly for setting up the broadband path. Each SNMS 207 has the address of all the SNMSs 207 in its adjacent domains. Each SNMS 207 also has the routing information to identify the adjacent domain to reach the destination domain. The SNMS 207 stores the access gateway ports to these adjacent domains in the broadband domain configuration data table.

As an alternate option, a pseudo-broadcast mode can be implemented wherein the SNMS 207 parses the destination subscriber ID, e.g., called number and identifies all of the domains in the general direction of the destination domain. This information is stored in the broadband domain configuration data table as an optional field. The SNMS 207 then replicates the routing message to each of these domains, and the process is repeated at each SNMS 207. As the broadband connection request message converges towards the destination domain, the participating SNMS′ 207 exchange routing information, which includes the number of hops and cost per hop. Finally, only one route will be selected by the routing algorithm and all other routes abandoned.

For broadband connections transcending multiple domains, the SNMS 207 needs to identify the gateway port of the next domain in the broadband path to the destination domain. The SNMS 207 first checks for an entry of the destination domain SNMS 207 in the local routing table. If an entry for the destination SNMS 207 is not found in the routing table, the SNMS 207 sends a message to its neighbor SNMS′ 207 requesting for the adjacent domain in the path to the destination domain. The neighbor SNMS′ 207 confers the topology of the network configuration to identify the adjacent domain and sends a response with the adjacent domain information. This information includes the SNMS 207 address of the adjacent domain and the gateway port identification of the adjacent domain. The SNMS 207 updates the routing table and maps the destination domain with the adjacent domain.

To establish an end-to-end broadband path, the special network configuration procedure requires SNMS 207 in one or more domains to establish the broadband path within the domain. Each SNMS 207 has the responsibility to identify the starting and ending termination points, select and reserve the resources for the optimum broadband path between these two termination points.

The following are some of the common network configuration modes, and their setup procedures:

For an Intra-domain call, the originating and destination subscribers both reside in the same domain. The SNMS 207 identifies the starting and ending termination points from its local database and computes the optimum broadband path between the two termination points. The SNMS 207 then constructs and sends the provisioning commands to the participating EMS/NMS 206 or network elements 204, 205 to establish the broadband connection.

There are three types of calls that fall into this category, originating domain call, terminating domain call, and the inter-domain call. For an originating domain call, the SNMS 207 retrieves the starting termination point from the subscriber user data table and the destination termination point as described in the adjacent domain gateway-port identification and routing table updates section above. The SNMS 207 computes the optimum broadband path between the two termination points, constructs and send the provisioning commands to the participating EMS/NMS 206 or network elements 204, 205 to establish the broadband connection. The SNMS 207 then reconstructs and sends the Call Setup Message to the SNMS 207 in the adjacent domain.

If it is a terminating domain call, the SNMS 207 retrieves the destination termination point from the subscriber user data table and the starting termination point as described in the adjacent domain gateway-port identification and Routing table updates section above. The SNMS 207 computes the optimum broadband path between the two termination points, constructs, and sends the provisioning commands to the participating EMS/NMS 206 or network elements 204, 205 to establish the broadband connection.

If it is an Inter-domain call, and the domain is an intermediate LEC domain, the SNMS 207 retrieves the starting and destination termination points as described in the Adjacent domain gateway-port identification and Routing table updates section. The SNMS 207 computes the optimum broadband path between the two termination points, constructs, and sends the provisioning commands to the participating EMS/NMS 206 or network elements 204, 205 to establish the broadband connection. The SNMS 207 then reconstructs and sends the Call Setup Message to the SNMS 207 in the adjacent domain.

For the Inter-domain Inter-Exchange Carrier Call, it is similar to the Inter-domain call. The IC domain SNMS 207 retrieves the starting and destination termination points as described in the Adjacent domain gateway-port identification and Routing table updates section above. The SNMS 207 computes the optimum broadband path between the two termination points, constructs, and sends the provisioning commands to the participating EMS/NMS 206 or network elements 204, 205 to establish the broadband connection. The SNMS 207 then reconstructs and sends the Call Setup Message to the SNMS 207 in the adjacent domain.

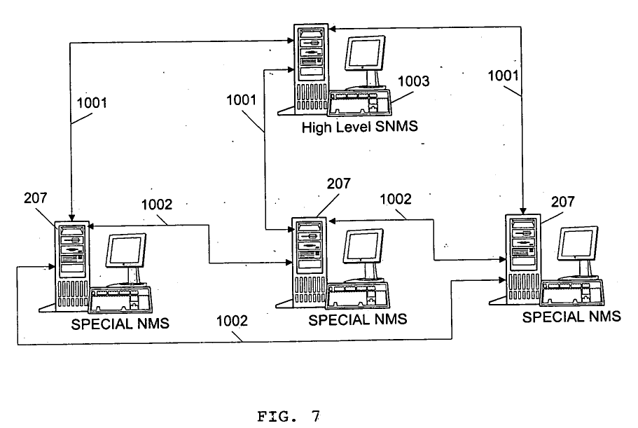

Referring to FIG. 7, the SNMS 207 communicates with the network elements via the EMS/NMS or directly depending on the service provider's management system architecture to manage all of the allocated broadband resources of these network elements. The higher level SNMS 207 in the hierarchy of the Special Network. Higher Level SNMS (“HLSNMS”) 1003, may be deployed in larger networks or network with wider geographic dispersion. The SNMS 207 communicates with its peers 1002 and HLSNMS 1003, 1001 to establish the broadband connection. The SNMS 207 of the domain in which the call originates constructs the initial Call Setup Message. SNMS 207 may receive Call setup messages from either HLSNMS 1003 or the adjacent domain SNMS 207.

It is each SNMS's responsibility to establish the broadband path within its domain. The broadband connection may originate and terminate within the same domain or span over multiple SNMS 207 domain. If the broadband connection spans beyond a SNMS 207 domain, the SNMS 207 will reserve the bandwidth for the path within its domain and send a connection request to the SNMS 207 in the adjacent domain either directly or via the HLSNMS 1003.

In the peer-to-peer mode, the SNMS 207 communicate with each other directly for setting up the broadband path. Each SNMS 207 has the address of all the SNMS 207 in its adjacent domains. Each SNMS 207 also has the routing information to identify the adjacent domain to reach the destination domain. This information maybe pre-configured or obtained from the HLSNMS 1003. The SNMS 207 stores the access gateway ports to these adjacent domains in the Broadband Domain Configuration Data table.

As an alternate network configuration, the SNMS 207 of the domain where the broadband call originates will send the Call Setup Message to the HLSNMS 1003. The HLSNMS 1003 then selects the end-to-end broadband path from the network configuration topology and identifies each of the domains in the broadband path. The HLSNMS 1003 then sends the Call Setup Message to the SNMS 207 in each of these domains. The specific connection termination-points for intermediate domain connections may be sent by HLSNMS 1003 or the SNMS 207 themselves can compute this information from their adjacency tables. Where the network spans multiple carriers' resources the Call setup message between the HLSNMS 1003 and SNMS 207 may be routed via the SS7 network.

The three embodiments shown and described herein are only exemplary. Even though numerous characteristics and advantages of the present invention have been set forth in the foregoing description together with details of the methods of the invention, the disclosure is illustrative only and changes may be made within the principles of the invention to the full extent indicated by the broad general meaning of the terms used in the attached claims.

What is claimed is:

1. A system for facilitating a broadband telecommunications path, comprising:
a non-broadband guide-wire;
a high bandwidth channel;
a means for correlating a user of the non-broadband guide-wire and a high bandwidth channel;
the non-broadband guide-wire adapted to determine a path for a high bandwidth channel; and
a means for using the non-broadband guide wire to allocate the high bandwidth channel dynamically as user calls are established and terminated.

2. The system of claim 1, wherein the non-broadband guide wire comprises the public switched telephone network (“PSTN”).

3. The system of claim 2, wherein the PSTN non-broadband guide wire utilizes the SS7 network protocol.

4. The system of claim 3, wherein the SS7 network is used to set up the high bandwidth channel, utilizing the end points for termination points and traversed switches as guides to set up the most efficient path.

5. The system of claim 4, adapted to make use of the spare capacity of a SONET or DCS network for setting up and tearing down the high bandwidth channel paths; and
the system adapted to allocate bandwidth dynamically as calls are established and terminated.

6. The system of claim 1, further comprising:
the system being adapted to first establish a DS0 call;
the system being adapted to query a called party to determine if it is equipped to set up a high bandwidth channel;
the system being adapted to establish a DS0 call if the called party is unable to set up a high bandwidth channel; and
the system being adapted to initiate a high bandwidth channel if a called party is able to support a high bandwidth channel.

7. The system of claim 6, further comprising a means for allocating the high bandwidth channel comprising:
a database for customers comprising a number of DS1s/VT1.5 granulars unit or bearer channels adapted to be allocated for the broadband call;
a special network manager adapted to query resources along a broadband path;
the special network manager being adapted to coordinate the traversal of network elements that can be remotely provisioned;
the special network manager being adapted to support DS1 or VT1.5 granular unit provisioning;
the database for customers and special network manager being coupled to facilitate the provisioning and tracking of the high bandwidth services.

8. The system of claim 7, wherein the special network manager is adapted to allocate higher granular units, including STS1 units.

9. The system of claim 8, wherein the special network manager is adapted to network elements that have spare capacity.

10. The system of claim 9, wherein the special network manager is adapted to permit the high channel bandwidth can cross LATA and carrier boundaries by passing through gateway network elements.

11. The system of claim 7, further comprising:
the special network manager being adapted to determine the best path for the high bandwidth channel; and
the special network manager being adapted to reserve the resources necessary to implement the high bandwidth channel.

12. The system of claim 11, wherein the special network manager is adapted to issue a series of provisioning commands to all of the targeted network elements in order to provision the high bandwidth channels.

13. The system of claim 12, wherein the special network manager is adapted to issue supervision tones or messages to a user concerning the status of a high bandwidth channel.

14. The system of claim 13, further comprising the special network manager being located between the SS7 network and the EMS systems of the individual network elements.

15. The system of claim 14, further comprising the special network manager being adapted to communicate with the EMS network over a standard CORBA interface, or TL1 or SNMP.

16. The system of claim 1, wherein broadband nodes on the high bandwidth channel comprise HDSL (HDSL2/4) line cards with concentration mechanisms operable to oversubscribe network bandwidth.

17. A system for using a public switched telecommunications network (PSTN) as a guide wire for a broadband network, comprising:
a special network manager being connected to the PSTN and a broadband network;
the special network manager being adapted to use the PSTN to determine the end points for a call; and
the special network manager being adapted to use the PSTN to trigger a broadband network to be setup, torn down, and modified according to predetermined commands.

18. A method for managing a SS7 triggered broadband communication session, comprising:
initiating, by a first termination point, a first communication session processible by an SS7 network to a second termination point, the first communication session indicating a broadband communication session is intended between the first and second termination points;
checking whether the broadband communication session can be established between the first and second termination points;
determining a communication path for the broadband communication session;
provisioning one or more network resources for the broadband communication session through the determined communication path; and
terminating the first communication session upon an initiation of the broadband communication session.

19. The method for managing a SS7 triggered broadband communication session of claim 18, further comprising using the PSTN network as a guide-wire for the broadband communication session.

20. The method for managing a SS7 triggered broadband communication session of claim 18 further comprising switching the broadband network at the SONET, ADM and/or DCS level.

21. The method for managing a SS7 triggered broadband communication session of claim 18 further comprising utilizing a call center to gain information about the end stations and triggers the broadband network via an interface to the SS7 based on provisioned information

22. The method for managing a SS7 triggered broadband communication session of claim 18 further comprising utilizing a self discovering algorithm whereby a system can determine its self domain broadband network and receive neighboring domain information.

23. The method for managing a SS7 triggered broadband communication session of claim 22 further comprising identifying a mechanism for utilizing a hierarchical management network to provide wider area and/or global area routing information.

24. The method for managing a SS7 triggered broadband communication session of claim 18 further comprising utilizing linkages between information stored in the SS7's SCP and the broadband management system.

25. The method for managing a SS7 triggered broadband communication session of claim 18 utilizing routing algorithms based on the routing concept of advanced intelligent network, broadband network and IP network.

26. The method for managing a SS7 triggered broadband communication session of claim 25 further comprising:
collecting relevant network data from the SS7 network and broadband network into special routing databases; and
based on called and calling subscriber data, finding the shortest routing path in the special routing database between two termination points in the broadband network.
